(19) United States
(12) Patent Application Publication
(10) Pub. No.: US 2014/0368116 A1
(43) Pub. Date: Dec. 18, 2014

(54) WIRELESS LIGHTING CONTROL

(71) Applicant: Jeffrey D. Walters, Speculator, NY (US)

(72) Inventor: Jeffrey D. Walters, Speculator, NY (US)

(21) Appl. No.: 14/306,225

(22) Filed: Jun. 16, 2014

Related U.S. Application Data
(60) Provisional application No. 61/835,475, filed on Jun. 14, 2013.

(51) Int. Cl. H05B 33/08

(52) U.S. Cl. CPC H05B 33/0842
USPC 315/152

(57) ABSTRACT

In a group of associated luminaires, a master luminaire may receive control signals from an external controller, such as over a set (pair) of wires (input leads), and will pass these signals wirelessly (via signaling LEDs and phototransistors) to slave luminaires. Hence, the slave luminaires need not have input leads or control wires extending therefrom. Eliminating wires extending from luminaires may increase the reliability and longevity of the luminaires. Various modulation schemes may be applied to address individual slave luminaires or groups thereof. Method and Apparatus are disclosed.

### CROSS REFERENCE TO RELATED APPLICATION(S)

Priority is claimed from provisional patent application Ser. No. 61/835,475 filed Jun. 14, 2013, and incorporated in its entirety by reference herein.

### TECHNICAL FIELD

The invention relates to luminaires and, more particularly, to control and dimming of a luminaire or group of luminaires and, more particularly, to luminaires comprising an array of lighting LEDs, such as for illuminating large areas such as parking lots with a plurality of luminaires which may be controlled (such as for dimming or increasing light output) from an external controller.

### BACKGROUND

LED (light emitting diode) lighting fixtures, which may be referred to herein as “luminaires” are often used for street lighting and large area lighting indoors or outdoors. Often, a plurality or group of luminaires will be used to illuminate a large area. In the present disclosure, the terms luminaire and fixture may be used interchangeably and should be understood as a reference to an LED Lighting fixture or luminaire, unless otherwise stated or clearly implied by the context in which it is used.

LED luminaires are characterized by one or more rows of LEDs that are mounted on at least one level (planar) mounting board (or printed circuit board, PCB) to generally form at least one planar array of LEDs. To conduct heat away from the LED base junctions, a metal PCB may be used, and may be referred to as a “metal core board” or MCB. In the descriptions set forth herein, MCBs may be referred to as examples of PCBs. Thus there may be more than one planar array of LEDs in a single luminaire.

Luminaires may typically be mounted high above ground, such as on a 10 meter pole, and the MCB may be oriented with the LEDs facing downward to illuminate an area. The fixture provides a housing for the MCB (and LEDs), and may also comprise optical elements, such as lenses or filters, or simply a cover glass to protect the LEDs (and the MCB, and its other electronic components) from the environment. The fixture itself may be relatively thin, and the optical elements may be very close-fitting around the individual LEDs. A protective cover glass may also be located close to the surface of the MCB, hence close to the LEDs.

At least one driver (or drive circuitry) is incorporated in the luminaire to control and regulate operating parameters of the LEDs such as the voltage and/or current supplied to them, thereby regulating such LED variables as light output intensity and/or color, and internal heating that can cause early failure. The driver circuitry may include some form of a microprocessor and/or firmware logic. The driver may respond to input of external signals to adjust the operating parameter values, thereby achieving changes in the LED variables. For example, a voltage input may vary the light output level as in “dimming” the luminaire. In some fixtures, the LED driver circuit is mounted on the MCB, and integrated with the LED circuitry of the MCB to provide a single modular unit for the LED light source in the fixture, i.e., an LED module.

To dim the luminaire, an input signal, such as a voltage, may be provided by (typically) two input leads (wires) to the driver. These two leads may be referred to as “dimming control wires”, or simply as “control leads”. The LED module, with other circuitry which may be co-located on the MCB) is powered by two power leads (typically wires) connected to an AC power line feed (mains).

Wire connections to or in a fixture tend to be a source of problems including early failure. Adding a pair of control leads (such as dimming control wires) that must be connected to the driver adds to the likelihood of problems. Also, the two control leads must be routed from each of the luminaires all the way to a remote (dimming) controller. Thus a way of delivering the dimming control signal without using wires (“wirelessly”) would be desirable.

### Some Related Patents and Publications

U.S. Pat. No. 8,442,785 (Walters et al., 2013), incorporated by reference herein, discloses system and method for streetlight monitoring diagnostics. One or more example diagnostics may be implemented as part of an intelligent luminaire manager or other radio frequency (RF) device that is in communication with an equipment or fixture such as a luminaire. Example diagnostics can determine a status such as a fixture malfunction, a cycling condition, a miswiring configuration, or another condition. The determined status can be wirelessly transmitted from the intelligent luminaire manager or other radio frequency device to a network server via a network. The network may be a network of intelligent luminaire managers and/or RF devices.

U.S. Pat. No. 6,452,339 (Morrissey et al., 2002) discloses a photocontroller diagnostic system including a photocontroller with a sensor for determining the presence of daylight, and a relay, responsive to the sensor, for de-energizing a lamp during periods of daylight. The diagnostic subsystem is responsive to the photocontroller, and includes a microprocessor programmed to verify the operability of the relay and/or the sensor, and to transmit a signal representative of the operability of the relay or the sensor.

### SUMMARY

It is an object of the invention to provide an improved technique (method and enabling apparatus) for controlling the operation of an LED lighting array in a luminaire, thereby controlling the luminaire. Preferably the technique controls dimming of the output of the luminaire, or a plurality (group) of luminaires.

According to the invention, generally, a master luminaire may receive control signals from an external controller, such as over a set (pair) of wires (input leads), and will pass these signals wirelessly (via signaling LEDs and phototransistors) to slave luminaires. Hence, the slave luminaires need not have input leads or control wires extending therefrom. Eliminating wires extending from luminaires may increase the reliability and longevity of the luminaires. Various modulation schemes may be applied to address individual slave luminaires or groups thereof.

According to some embodiments (examples) of the invention, a method of controlling the operation of one or more luminaires comprising LED lighting arrays and driver/control circuitry may comprise: providing a control signal to one of the luminaires, said luminaire operating as a master luminaire and comprising an optical signal transmitter for transmitting optical control signals to other luminaires; and providing at least some of the other luminaires with optical signal receivers for receiving the optical control signals; wherein the optical control signals control an operating parameter of the LED lighting array. The control signal may be provided via input leads to the master luminaire; and the other luminaires with optical signal receivers may not have input leads. The control signal may be provided wirelessly to the master luminaire. The control signal may be a dimming control signal. The operating parameter may be selected from the group consisting of intensity, color and strobe. At least some of the other luminaires may comprise both an optical signal transmitter and optical signal receiver. At least one of the luminaires may be capable of receiving an optical control signal from the master luminaire and re-transmitting the optical control signal. The control signal may be modulated to address selected ones of the optical signal receivers in the different luminaires. Some of the fixtures may be controlled separately from other ones of the fixtures. A subset of all of the other luminaires may be controlled.

According to some embodiments (examples) of the invention, a luminaire may comprise: at least one LED lighting array disposed on a printed circuit board (PCB); driver and control circuitry; and at least one of an optical signal transmitter and optical signal receiver. The PCB may be a metal circuit board (MCB). Power leads may extend from the luminaire. At least one of the luminaires may comprise both an optical signal transmitter and optical signal receiver. The optical signal transmitter may comprise a signaling LED. The optical signal receiver may comprise a photodiode. The light output from the signaling LED may be in the visible light spectrum. The signaling LED may comprise monochromatic AlInGaP emitting at 630 nanometers. The light output from the signaling LED may be modulated at a selected modulation frequency higher than normally seen in room illumination. Filtering circuitry may be added to the optical signal receiver to make it selectively responsive to the selected modulation frequency.

### BRIEF DESCRIPTION OF THE DRAWINGS

Reference may be made to embodiments of the invention, non-limiting examples of which may be illustrated in the accompanying drawing figures (FIGs). Some elements in the figures may be exaggerated, others may be omitted, for illustrative clarity. Similar elements in various figures may be similarly numbered, such as element 215 being similar to element 115; and the most significant digit(s) of the reference numeral may correspond to the figure number (such as FIG. “2”). Terms of orientation such as “top”, “bottom”, “left”, “right”, “front”, “back”, and the like may be used to indicate relative positions of elements with respect to one another, or portions of a given element with respect to one another.

FIG. 1A is a diagram, in plan view, of a luminaire of the prior art.

FIG. 1B is a diagram, in side cross-sectional view, of the luminaire of FIG. 1A.

FIG. 2 is a diagram of a plurality of associated luminaires, and may be used to illustrate various embodiments of the invention.

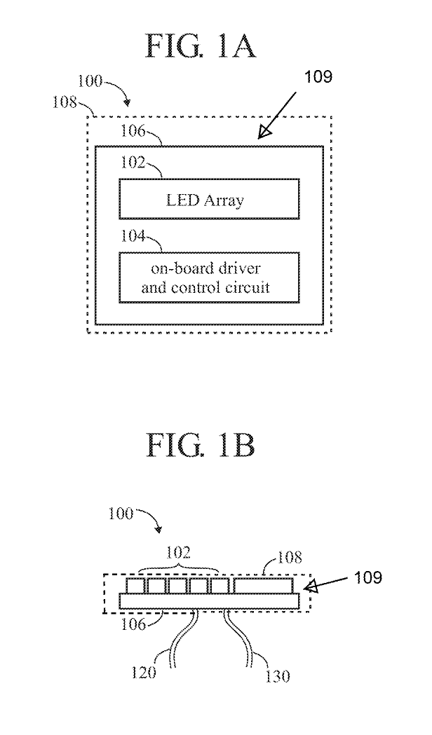

KEY TO REFERENCE NUMBERS
AS SHOWN IN FIGS. 1A, 1B

| | |
|---|---|
| 100 | luminaire or fixture for LED lighting |
| 102 | LED lighting array |
| 104 | LED driver (and control circuitry) |
| 106 | MCB (metal core board), which is a type of printed circuit board |
| | (PCB) used for mounting LEDs |
| 108 | housing of fixture/luminaire components |
| 109 | LED lighting module, modular light source |
| 120 | control leads (such as dimming control wires) |
| 130 | power wires (leads) |

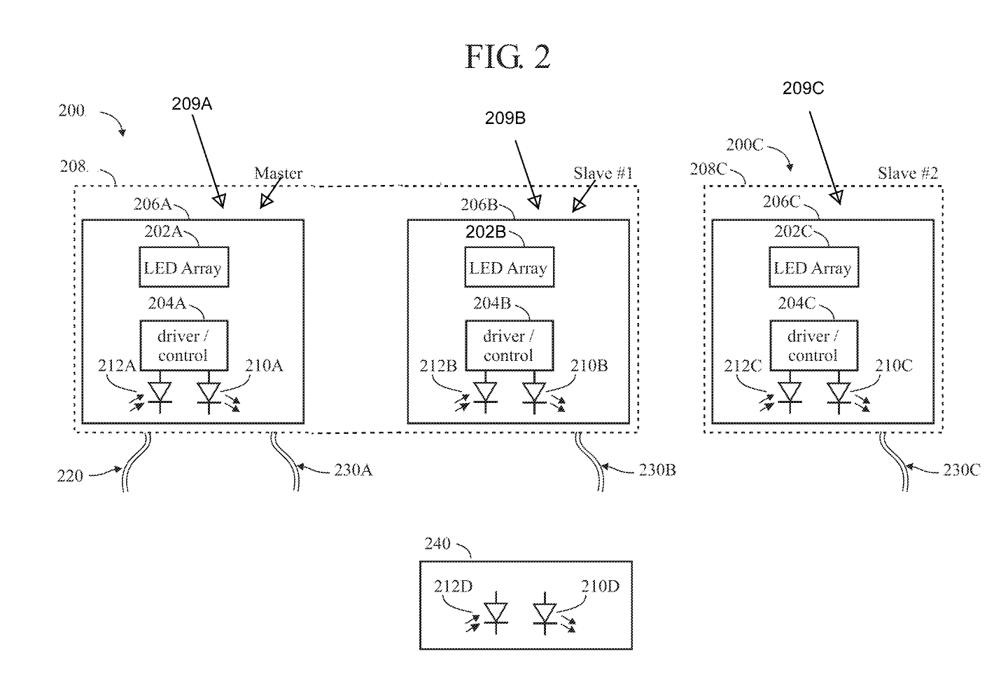

AS SHOWN IN FIG. 2

| | |
|---|---|
| 200 | luminaire or fixture for LED lighting |
| 202 | LED lighting array |
| 204 | LED driver and control circuitry |
| 206 | MCB (metal core board), type of printed circuit board (PCB) |
| 208 | housing of fixture/luminaire components |
| 209 | LED lighting module, modular light source |
| 210 | signal transmitter |
| 212 | signal receiver |
| A, B, | Instances of an element |
| C, D | |
| 220 | control leads (such as dimming control wires) |
| 230 | power wires (leads) |
| 240 | remote control device |

### DETAILED DESCRIPTION

Various embodiments will be described to illustrate teachings of the invention(s), and should be construed as illustrative rather than limiting. Although the invention may be described in the context of various exemplary embodiments, it should be understood that it is not intended to limit the invention to these particular embodiments, and individual features of various embodiments may be combined with one another.

As used herein, a “drive circuit” (or “driver circuit”), or simply “driver”, may refer to an electrical circuit or other electronic component(s) used to control another circuit or other component, such as a high-power transistor. As applied to the luminaires disclosed herein, a driver may control a current output (lout) to an array of LEDs in a luminaire, based on the level of an input voltage (Vin) supplied thereto, thereby controlling the luminosity of the luminaire as a function of the input voltage.

The present disclosure will be primarily stated in terms of embodiments wherein a luminaire (or fixture) has a single LED light source comprising a plurality of LEDs combined as a unit and mounted within a housing of the luminaire, however it is known to locate more than one LED light source unit (module) in a luminaire, therefor references herein to a luminaire or fixture should be understood as references to one or more LED modules all mounted in a housing of the luminaire.

FIG. 1A (plan view) and FIG. 1B (side view) show a luminaire 100 comprising an LED lighting array 102 disposed on one side (top, as viewed in FIG. 1B) of an MCB 106. A driver 104 and other control circuitry may also be disposed on a side of the MCB 106. The MCB 106, LED array 102 and driver/control circuitry 104 form a modular LED light source (LED module 109), wherein one or more LED modules 109 may be disposed in one, or in a plurality of housings 108 of luminaires 100. The luminaire/fixture housing 108 may fit closely around the MCB, and may include a cover glass (not shown) which is disposed very closely to the LED lighting array 102. It should be understood that FIGS. 1A and 1B are substantially a representational block diagram or schematic wherein the various elements shown in FIGS. 1A and 1B are not drawn to scale, some elements being drawn larger (or smaller) than they actually are, for the sake of illustrative clarity.

In FIG. 1B (showing the housing 108 only partially) it can best be seen that a pair of control leads (such as dimming control wires) 120 may extend from the MCB 106. These wires would typically be connected with a remote controller (not shown), such as described in U.S. Pat. No. 8,442,785, which could control and monitor various operating parameters of the luminaire 100, or other luminaires associated with the luminaire 100. An exemplary parameter of interest, which may be referred to herein as exemplary of any parameter of interest is intensity, or the brightness of the light being produced by the LED lighting array(s).

Each luminaire is also provided with a pair of power wires 130 extending from the MCB 106 for powering (such as with AC) the LED array(s) 102 and associated driver/control circuitry 104. The two pair of wires 120 (control) and 130 (power) may extend down a utility pole to which the luminaire 100 is mounted, and the luminaire may be mounted with its LED lighting array 102 facing downward (inverse to what is shown in FIG. 1B) to illuminate an area desired to be illuminated.

U.S. Pat. No. 8,442,785 illustrates (FIG. 2 therein) a plurality of street lights (200) that form part of a light system. The street lights networked together using intelligent luminaire managers. Each street light (200) is equipped with an intelligent luminaire manager (112) mounted, for example, on top of a light fixture (204) of street lamp (200). An intelligent luminaire manager (112) may communicate using an RF communication link with its neighbors mounted on neighboring street lights (200). In an embodiment, an intelligent luminaire manager (112) also is capable of communicating with other nearby devices that include, for example, an RF device (202). This communication can be unidirectional or bidirectional. The unidirectional communication can be from an RF device (202) to the intelligent luminaire manager (112) or from the intelligent luminaire manager (112) to RF device (202) depending on whether RF device (202) is a transmitting device or a receiving device. Communication with an RF device (202) may be established when an RF device (202) enters into the proximity or communication space of an intelligent luminaire manager (112) and is authorized to become a part of the network formed by intelligent luminaire manager (112) and its neighbors. The communication links between intelligent luminaire managers (112) can include, for example, power line carrier communication links or optical communication links. In an example embodiment, the intelligent luminaire manager (112) includes at least one LED (not shown) internal or external to enclosure (301) for communicating with maintenance crews. In one embodiment, the LED transmits infrared signals that are received by PDA-hosted field unit (122).

As further disclosed in U.S. Pat. No. 8,442,785, in an example embodiment, luminaire (200) is a conventional luminaire such as, for example, a street light. Controller (310) may include a processor (318), memory (320), and an interface subsystem (322). Memory (320) stores a variety of programs and/or computer-executable instructions that are executed and/or implemented using processor (318). These programs and/or computer-executable instructions may include, for example, a luminaire control program (324), luminaire and intelligent luminaire manager configuration program (326), status reporting program (328), and other optional programs (330).

The present invention generally presents an alternative (or improvement) to the communication links (RF, power line or optical) disclosed in U.S. Pat. No. 8,442,785, but otherwise may incorporate many of the concepts or components disclosed therein, particularly with regard to interacting with (which may include directing and monitoring the operation of) a plurality of luminaires. As part of the improvements, however, it will be seen that the present invention may be used for communication/interaction among a plurality of LED lighting arrays that may be located in the same, or in different fixture housings.

Infrared (IR) Signaling to and Between Luminaires and LED Arrays

In general, the invention concerns wireless, optical communication of lighting control signals (e.g., light level/amount, or “dimming”, color, etc.) to and between LED lighting arrays housed in lighting fixtures (luminaires), more particularly large area lighting fixtures that use one or more modular arrays of high power LEDs as the light source. LED streetlights and parking lot lights on tall poles are examples of the types of luminaires being discussed herein, and to which the techniques of the present invention may be applied. However, rather than using RF communication between fixtures, such as disclosed in U.S. Pat. No. 8,442,785, photo-active optical transmitters (typically low power “signaling” LEDs, operating in the infrared range) and optical receivers (photo detectors, such as phototransistors) may be used for signaling between a plurality (group of associated) luminaires, typically with (but not limited to) one luminaire acting as “master”, and the other associated luminaires acting as “slaves”. The additional components (signaling LEDs, phototransistors) may readily be incorporated onto the MCB already present in an LED lighting fixture (especially large area lighting fixtures which use a planar array of LEDs mounted on MCDs), taking advantage of fixture designs where the driver and control circuitry 104 is located on the same circuit board 106 as the LED lighting array 102.

In the description that follows, dimming control signals may be referred to as exemplary of any control signal for controlling the operation of the luminaires, such as signals turning on and off selected ones of luminaires in a group of associated luminaires, causing selected ones of the luminaires to flash on and off, changing color of the light emitted by the luminaire, and the like. Signals indicating an operating condition of a given luminaire (such as its “health”) may also be included in the broad description of control signals.

According to an embodiment of the invention, generally, the master luminaire may receive control signals from an external controller, over a set (pair) of wires (input leads), and will pass these signals wirelessly (via signaling LEDs and phototransistors) to the slave luminaires. Hence, the slave luminaires need not have input leads or control wires (120) extending therefrom. Eliminating wires extending from luminaires may increase the reliability and longevity of the luminaires.

FIG. 2 show a plurality (three shown) of associated LED lighting arrays 202A, 202B, 202C (each of which may be referred to as “202”), each array 202 being disposed in its own fixture/luminaire 200A, 200B, 200C (each of which may be referred to as “200”), respectively. However, it is within the scope of the invention that there may be several LED lighting arrays 202 in a single fixture 200. FIG. 2 is illustrative of a control concept between/among self-ballasted LED light sources, and various methods of controlling the operation of one or more luminaires. (FIG. 2 is diagrammatic, and a cross-sectional view comparable to FIG. 1B is not included, for illustrative clarity.)

Each LED lighting array 202 is provided on a printed circuit board (PCB) 206A, 206B, 206C (each of which may be referred to as “206”) which may be a metal circuit board (MCB). Each MCB 206 may further comprise an on-board driver and control circuit 204A, 204B, 204C (each of which may be referred to as “204”) which may be associated with a respective one of the LED lighting arrays 202. Each MCB 206, and the components mounted thereon, forms an LED module 209A, 209B, 209C (each of which may be referred to as “209”) that may be disposed in a respective housing 208A, 208B, 208C (each of which may be referred to as “208”). Power leads 230A, 230B, 230C (each of which may be referred to as “230”) provide operating power to each of the luminaires 200.

One of the luminaires 200A may be designated as a “master” luminaire, and may be provided with input leads (control wires) 220 extending therefrom (to an external controller, not shown). The luminaires 200B and 200C may be “slave” luminaires, and do not have control leads (220) extending therefrom. The present invention therefore provides a way to eliminate the control leads (220) for most, if not all, LED arrays 202 and/or fixtures 200 in an associated group (such as a networked plurality) of luminaires 200.

Each of the LED lighting arrays 202 may have a signal transmitter 210A, 210B, 210C (each of which may be referred to as “210”) and/or a signal receiver 212A, 212B, 212C (each of which may be referred to as “212) on the MCB 206 and connected with the on-board driver and control circuit 204, for the purpose of transmitting and/or receiving control signals (e.g., dimming control data) from one board 206 to another (or, from one luminaire 200 to another). The signal transmitters 210 may be LEDs. The signal receivers 212 may be light sensors, such as photo-sensitive diodes (or photodiodes, or photo-sensitive transistors, or phototransistors). More particularly,

the luminaire 200A is shown having a signal transmitter 210A. Optionally, it may also have a signal receiver 212A. Control leads 220 extend from the luminaire to an external controller (not shown).

the luminaire 200B is shown having a signal transmitter 210B and a signal receiver 212B.

the luminaire 202C is shown having a signal receiver 212C. Optionally, it may also have a signal transmitter 210C.

In some embodiments of the invention, the luminaire 200A may function as a “master” (Master) that receives control signals (such as for dimming some or all of the luminaires) via a pair of input (or control) leads 220, and therefore does not need to have a signal receiver 212. The other two luminaires 200B, 200C may function as “slaves” (Slave #1, Slave #2), may be provided with signal receivers 212 which will receive their control signals from a transmitter 210 on another board (in this example, from the Master luminaire 200A). Optionally, the slave luminaires 200B, 200C board may be provided with signal transmitters 210 so that they can re-transmit a control signal received from the master or another slave luminaire. For example,

the master luminaire 200A receives a control signal over the input (control) leads 220, and transmits an optical control signal for the other luminaires from its optical signal transmitter 210A,

the optical control signal from the master luminaire 200A is received by the optical signal receiver 212B in the slave luminaire 200B which then re-transmits the control signal from its optical signal transmitter 210B, and

the optical control signal from the slave luminaire 200B is received by the signal receiver 212C in the slave luminaire 200C.

Other variations are possible, for example (but not limited to),

the master luminaire 200A receives a control signal over the control leads 220, and transmits an optical control signal from its optical signal transmitter 210A, and

the optical control signal from the master luminaire 200A is received by the optical signal receivers 212 in the luminaires 200B and 200C, and need not be re-transmitted.

The MCB boards 206 may be different than one another. For example, add an optical signal emitting LED (optical signal transmitter 210) and/or a control signal photo-detector (optical signal receiver 212) to driver (and control) components already on metal core board 206. The signaling LED (signal transmitter 210) would not be needed in all embodiments, or for all of the MCB boards 206 of all of the luminaires 202—for example, for some or all of the slave boards (MCBs) 206 in slave luminaires, an optical signal transmitter 210 may not be needed, and for a master board (MCB) an optical signal receiver would not be needed if the master luminaire receives its input signals in another way (hard-wired, via input lines/control leads/dimming control leads 220). Although all of the luminaires 200 have power leads 230 connecting thereto, these power leads tend to be of a higher gauge (thicker) copper wire and to be more durable than signaling leads (220) which may be formed of small gauge (thinner) wire.

Advantageously, all of the MCB boards 206 may be identical with one another (“generic”), comprising both a signal transmitter 210 and a signal receiver 212. A DIP switch or a simple jumper (not shown) or other suitable means may be provided to personalize a generic MCB board as either a “master” or “slave”. Alternatively, for example, a generic MCB board may be self-configuring based on whether it receives control signals via its control leads 220.

In a variation of the above, rather than receiving control signals via its control leads 220, the master luminaire 200A may receive its control signals, wirelessly (optically), from a remote control device 240 which is provided with an optical signal transmitter 210D for transmitting optical signals to one of more of the luminaires. The remote control device 240 may be part of an overall external controller (not specifically shown). The remote control device 240 may also be provided with an optical signal receiver 212D to receive optical signals from one or more of the luminaires 200.

There has thus been shown various ways of controlling a plurality of associated luminaires 200, in either an automated or manual manner, with control signals being either provided by wires (control leads 220) to one of the plurality of luminaires, or being broadcast (from a remote device 240) to all of the luminaires 200.

U.S. Pat. No. 8,442,785 discloses using radio frequency transmitters and receivers to create a wireless network among lighting fixtures and remote monitoring or control units. A problem with using RF is that it requires a lot of additional circuitry on the MCB (or PCB), may require FCC licensing, and must be designed to avoid radio frequency interference (RFI) problems and possibly power conditioning problems with the LED power supply, driver/controller and the low-voltage current supply to the LEDs.

The present invention overcomes these problems by using optical signaling devices (210, 212) which do not cause any electrical or radio frequency interference problems, are inexpensive, and which may easily be implemented on existing MCBs along with the LEDs in the array (and drivers, and other control circuitry) which are being used for lighting.

The light output of the signaling LEDs 210 could be in the visible light spectrum, or essentially monochromatic AlInGaP emitting at 630 nanometers. Example: HLMP-RD11-J0000 (Avago Technologies). This is outside the range normally emitted by the other lighting LEDs in the array 202 which providing visible lighting, typically white or colored light. Alternatively, for the signal transmitters 210, an IR emitting LED could be used, which is also outside of the range emitted by the lighting LEDs 202. The optical signal receiver (photo detector) 212 may be chosen to have good sensitivity at 630 nanometer (or whatever the frequency output of the signal transmitter 210 is).

Additional circuitry may be added to the LED driver components to modulate the signaling LED 210 at a selected frequency higher than normally seen in room illumination—for example, at 40 KHz. Similarly, filtering circuitry may be added to the optical signal receiver (photo detector) 212 to make it sensitive/responsive selectively to radiation that is modulated at the selected modulation frequency (e.g., 40 KHz). If the driver circuit 206 uses a microprocessor (or if there is an on-board microprocessor or microcontroller), then both the signaling LED (210) emission modulating, and the signal photo detector (212) filtering may be implemented at least partially in software. Codes, such as pulse repetition codes or pulse width modulation, or other modulation schemes can be impressed (modulated) on the optical signals emitted by the optical signal transmitters 210 to address selected ones of the optical signal receivers 212 in the different luminaires. Different addresses can be built into data codes so that individual fixtures 200 can be controlled separately from other fixtures 200. Or, multiple fixtures (a selected subset of all of the associated fixtures/luminaires) can have same code so they can be controlled and communicate with each other if within signal detection range. (Optical signaling tends to be “line of sight”.)

With appropriate modulation, the combination of on-board optical transmitter (210) and/or on-board optical receiver (212) can be used to (wirelessly) transmit data signals between a Master LED lighting array 202A (or a remote control 240) and a Slave LED lighting array 202B. (As can be determined from context, the term “array” may be used broadly herein to refer to the modular set of components 109, 209 all mounted together with the array 102, 202 (of lighting LEDs) arranged on a single MCB 106, 206 of a luminaire 100, 200. The associated MCB 106, 206 (circuit board) may be similarly used for the same reason—i.e., there is a one-to-one correspondence between an MCB (e.g., 206B), an array 202B (of LEDs), an on-board driver 204B, and any additional components disclosed herein (such as optical-signaling components 210B and 212B and a controller (part of driver 204B) for the driver and/or optical signaling components). This is analogous to the more familiar practice of referring to an LED driver 104 which comprises “circuitry” and/or a microprocessor, making up the controller portion of the driver.

Some exemplary control data in a signal would be dimming commands—for example, a master array obtains dimming control signals from its two dimming leads (220), slave arrays do not need dimming lead wires since they may obtain their commands wirelessly (without wires, optically) from the master array. This saves wiring and associated cost, size & failure points. Furthermore, other commands can be given once a data link between arrays luminaires 200 is established—for example, strobe (flashing on/off) or color change.

Some advantages of the techniques disclosed herein may include, but are not limited to:

reducing or eliminating interconnect hard wiring

it is only required that a given array (or a selected one of the luminaires) can see/detect control signal optical emissions from another. In some cases, a given array may be sensible to (see/detect) control signals transmitted from more than one array in the group of arrays.

For luminaires comprising one or more LED arrays that have associated driver components on the array's MCB along with the lighting LEDs, adding another few parts (signaling LEDs) on the same board is a simple addition to the on-board circuitry.

Photo detectors are very inexpensive components (such as $0.05) with outstanding reliability, availability and small size. Temperature ratings of −40° C. to +105° C. are common.

As suggested above, one or more fixtures/LED Arrays could be controlled by a signaling source outside the fixture, in a manner similar to that of a TV (or other appliance) remote control.

The master luminaire/MCB functions in a manner similar to a remote control, receiving its input from the control lines (220) and outputting control signals to other luminaires/MCB's via its optical signal transmitter (low-power, signaling LED).

No UL (Underwriters Laboratories) high voltage issues are created by the addition of the low voltage signaling techniques (opto-transmitters 210 and opto-receivers 212) disclosed herein.

The optical signaling techniques disclosed herein may not be affected by ambient light, illumination, or any other radiation that isn't modulated at the selected modulation frequency.

While the invention has been described with respect to a limited number of embodiments, these should not be construed as limitations on the scope of the invention, but rather as examples of some of the embodiments. Those skilled in the art may envision other possible variations, modifications, and implementations that are also within the scope of the invention, as claimed and based on the disclosure(s) set forth herein.

What is claimed is:

1. A method of controlling the operation of one or more luminaires comprising LED lighting arrays and driver/control circuitry, the method comprising:
providing a control signal to one of the luminaires, said luminaire operating as a master luminaire and comprising an optical signal transmitter for transmitting optical control signals to other luminaires; and
providing at least some of the other luminaires with optical signal receivers for receiving the optical control signals;
wherein the optical control signals control an operating parameter of the LED lighting array.

2. The method of claim 1, wherein:
the control signal is provided via input leads to the master luminaire; and
the other luminaires with optical signal receivers do not have input leads.

3. The method of claim 1, wherein:
the control signal is provided wirelessly to the master luminaire.

4. The method of claim 1, wherein:
the control signal is a dimming control signal.

5. The method of claim 1, wherein:
the operating parameter is selected from the group consisting of intensity, color and strobe.

6. The method of claim 1, wherein:
at least some of the other luminaires comprise both an optical signal transmitter and optical signal receiver.

7. The method of claim 6, wherein:
at least one of the luminaires is capable of receiving an optical control signal from the master luminaire and re-transmitting the optical control signal.

8. The method of claim 6, further comprising:
modulating the optical control signal to address selected ones of the optical signal receivers in the different luminaires.

9. The method of claim 8, further comprising:
controlling some of the fixtures separately from other ones of the fixtures.

10. The method of claim 9, further comprising:
controlling a selected subset of all of the other luminaires.

11. A luminaire comprising:
an LED lighting array disposed on a printed circuit board (PCB);
driver and control circuitry; and
at least one of an optical signal transmitter and optical signal receiver.

12. The luminaire of claim 11, wherein:
the PCB is a metal circuit board (MCB).

13. The luminaire of claim 11, further comprising:
power leads extending from the luminaire.

14. The luminaire of claim 11, wherein:
at least one of the luminaires comprises both an optical signal transmitter and optical signal receiver.

15. The luminaire of claim 11, wherein:
the optical signal transmitter comprises a signaling LED.

16. The luminaire of claim 11, wherein:
the optical signal receiver comprises a photodiode.

17. The luminaire of claim 15, wherein:
light output from the signaling LED is in the visible light spectrum.

18. The luminaire of claim 15, wherein:
the signaling LED comprises monochromatic AlInGaP emitting at 630 nanometers.

19. The luminaire of claim 15, wherein:
light output from the signaling LED is modulated at a selected modulation frequency higher than normally seen in room illumination.

20. The luminaire of claim 19, further comprising:
filtering circuitry added to the optical signal receiver to make it selectively responsive to the selected modulation frequency.
